(19) United States
(12) Patent Application Publication
(10) Pub. No.: US 2006/0177109 A1
(43) Pub. Date: Aug. 10, 2006

(54) Combination casino table game imaging system for automatically recognizing the faces of players--as well as terrorists and other undesirables-- and for recognizing wagered gaming chips

(76) Inventor: Leonard Storch, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/325,702

(22) Filed: Dec. 20, 2002

Related U.S. Application Data
(60) Provisional application No. 60/342,256, filed on Dec. 21, 2001.

(51) Int. Cl. G06K 9/00; A63F 9/24

(52) U.S. Cl. 382/118; 463/25

(57) ABSTRACT

A fully automatic table game player tracking system for blackjack and other casino games is disclosed. The system utilizes a computer-controlled combination imaging system in each table game. The system captures facial images to compare with images stored in the casino's database in order to automatically identify players without the need to swipe a player's magnetic ID card. It also captures images of a player's wagered chips to automatically calculate his/her total bet, average bet, number of hands played, etc., in order to accurately rate a player to determine “comps” without using casino employees to make manual estimates of a player's betting activity. In addition, if their facial images are stored, casinos could also identify casino cheats and other undesirables, and, if facial images from the FBI, Interpol, etc., were also stored in the casino database or available online via the Internet or otherwise, the system could identify terrorists, drug dealers, counterfeiters and other criminals and threats to society.

### RELATED APPLICATION

This application claims the priority of provisional patent application Ser. No. 60/342,256 filed Dec. 21, 2001, the disclosure of which is incorporated herein by reference.

### BACKGROUND OF THE INVENTION

Casinos have been processing images of faces (facial recognition) captured from surveillance camera imaging devices, sometimes referred to as eyes-in-the-sky, in order to identify cheats and other undesirables so that such patrons can be automatically recognized and thereafter ejected or otherwise prevented from cheating and other wrong doing by casino personnel.

Two providers of facial recognition technology may be found at “www.visionics.com” and “www.viisage.com”. Recent U.S. patents include:

Steffens et al., Oct. 9, 2001, U.S. Pat. No. 6,301,370, Face recognition from video images;

Bortolussi et al., Sep. 18, 2001, U.S. Pat. No. 6,292,575, Real-time facial recognition and verification system;

Abdel-Mottaleb et al., Jul. 17, 2001, U.S. Pat. No. 6,263,113, Method for detecting a face in a digital image;

Cumbers, May 22, 2001, U.S. Pat. No. 6,234,900, Player tracking and identification system;

Cumbers, Nov. 7, 2000, U.S. Pat. No. 6,142,876, Player tracking and identification system;

Chang et al., Oct. 24, 2000, U.S. Pat. No. 6,137,896, Method of recognizing faces using range images;

Kuperstein et al., Oct. 3, 2000, U.S. Pat. No. 6,128,398, System, method and application for the recognition, verification and similarity ranking of facial or other object patterns;

Baluja et al., Oct. 3, 2000, U.S. Pat. No. 6,128,397, Method for finding all frontal faces in arbitrarily complex visual scenes; and

Lin, Aug. 22, 2000, U.S. Pat. No. 6,108,437, Face recognition apparatus, method, system and computer readable medium thereof.

The disclosures of all of the above U.S. patents are incorporated herein by reference.

The Cumbers '876 and '900 patents disclose the use of facial recognition to identify slot machine players and table game players so that a player's betting habits may be monitored for the purpose of awarding comps and other benefits (complimentary perks) to the player commensurate with his level of play. For a slot machine player, Cumbers also teaches how wager monitoring can be done automatically (12^{th} paragraph from the end of the Description in Cumbers' '876 and '900 patents): “In a known manner, each time the player makes a wager at the device 34, a data signal is generated indicative of the amount of the wager. Thus, as a player inputs coins or tokens into the device 34 to play, signals 40 are issued to the host processor 29.”

However, it is a different matter to determine the amount of wagers at a table game because one or more gaming chips of one or more denomination values may be used together to make up a given wager, whereas, in slot machine play, a player inserts particular denominations or values of coins or tokens one-at-a-time into a slot machine chute which has been adapted to accept such coins or tokens one-at-a-time so they can be counted individually and their physical attributes measured individually to detect and authenticate their value so a player's comp credits can be tallied and counterfeits can be avoided.

Some casino table game operators have tried to utilize various devices and technology to machine read the denominations of wagered chips in order to automatically determine the monetary amounts of a player's betting activity so that comps distributed by the casino will accurately reflect a player's betting activity. However, applicant's know of no such systems to read table game chips to be operating in any casino anywhere in the world.

The disclosures of applicants' pending patent application, titled, SYSTEM FOR MACHINE READING AND PROCESSING INFORMATION FROM GAMING CHIPS, application Ser. No. 09/335,100, and their patent, U.S. Pat. No. 4,814,589, issued Mar. 21, 1989, titled, INFORMATION TRANSFER AND USE, PARTICULARLY WITH RESPECT TO OBJECTS SUCH AS GAMBLING CHIPS, are incorporated herein by reference.

Other patents include:

Uhland, Jul. 23, 1985, U.S. Pat. No. 4,531,187, Game monitoring apparatus;

French et al., Jul. 29, 1997, U.S. Pat. No. 5,651,548, Gaming chips with electronic circuits scanned by antennas in gaming chip placement areas for tracking the movement of gaming chips within a casino apparatus and method;

Fishbine et al., Jul. 14, 1998 U.S. Pat. No. 5,781,647, Gambling chip recognition system;

Strisower, Mar. 7, 1996, U.S. Pat. No. 5,809,482, System for the tracking and management of transactions in a pit area of a gaming establishment; and, most recently,

Hogan, Jul. 31, 2001, U.S. Pat. No. 6,267,671, Game table player comp rating system and method therefor.

The disclosures of all of the above U.S. patents are incorporated herein by reference.

Imaging devices and components therefor and/or used therewith are well known in the art. Recent U.S. patents include:

Yoshimura et al., Nov. 13, 2001, U.S. Pat. No. 6,317,266, Coordinate input apparatus;

Yokonuma, Sep. 18, 2001, U.S. Pat. No. 6,292,630, Camera;

Hori, Jul. 10, 2001, U.S. Pat. No. 6,259,478, Full frame electronic shutter camera;

Chen, et al., Apr. 10, 2001, U.S. Pat. No. 6,215,113, CMOS active pixel sensor;

The disclosures of all of the above U.S. patents are incorporated herein by reference.

### SUMMARY OF THE INVENTION

The invention provides a combination imaging system that captures both facial images and images of wagered chips at casino table games such as blackjack. The present invention is particularly suitable for any game that uses particular betting positions assigned to each player. In addition to automatically identifying players, casinos could also identify cheats and other undesirables. Such a combination imaging system may also benefit our nation's interests by identifying terrorists, drug dealers, counterfeiters and other criminals and threats to society.

The invention provides for automatically obtaining, i.e., machine read, information from faces and gambling chips reliably during play on casino table games.

The invention provides for obtaining such information unobtrusively, with little or no interference in game play, and/or with little or no slowing of game play, particularly for identifying a player and starting, capturing information during, and ending, a playing session therefor.

The invention provides for fully automate information collection from gambling tables, particularly for card games and particularly for the purpose of identifying and comping players.

The invention provides for automatically obtaining information from gambling tables, and it provides a combination system to do so, as described in the foregoing, for player identification and comping and for other purposes.

The invention provides for enhanced casino-style game play while providing for automatic reading of information from a player's face in order to automatically identify a player and from gaming chips during game play for the purpose of determining the player's comps.

The invention provides for a system which accomplishes one or more of the foregoing which is simple to manufacture and operate and which is inexpensive to manufacture.

The invention provides for a programmed computer system for processing optical information from players' faces and optical information from their gaming chip(s) wagered at a plurality of respective playing positions on a gaming table, the system having a gaming table with playing positions each having a specified betting position for each player, and at least one imaging device associated with each of the plurality of playing positions, the imaging devices being situated to receive light from players' faces and from gaming chips players' wager at their respective betting positions, and the imaging devices providing electrical signals related to the players' faces and to the gaming chips, and at least one programmed computer processor coupled to receive said electrical signals from said imaging devices, the computer being caused by programming to process said electrical signals and thereby process optical information representing players' faces and optical information representing their wagered gaming chip(s).

The system's imaging devices may include at least a video camera and lens. The system's imaging devices may be located in the vicinity under the dealer's chip tray. The system's imaging devices may be mounted on one assembly, and/or on one printed circuit board.

The invention may also provide for a casino database to store facial images of players so that the face of a player who sits down to play may be compared to images stored in the casino database. When a match is made, the facial data from the database may be downloaded to the table computer for storage (at least for temporary storage) so that facial images captured from the imaging devices at the table and processed in the table's computer may be continually compared to the downloaded image. When a match may no longer be made from subsequent comparisons, it would indicate that the player has left and the table computer can then end that player's play session. Another play session may be started when the image of another face is captured.

The invention also provides for a programmed computer system for processing optical information from players' faces and optical information from their gaming chip(s) wagered at a plurality of respective playing positions on a gaming table, the system having at least the following: a gaming table with a specified betting position for each player, and at least one optical device (for example, a lens) associated with each of the plurality of playing positions, these optical devices being located in the vicinity under the dealer's chip tray and situated to receive light from players' faces and from gaming chips players wager at their respective betting positions, and at least one opto-electrical device (for example, a video camera) associated with each of the at least one optical device, the opto-electrical devices receiving light images from the optical devices and providing related electrical signals, and at least one programmed computer processor coupled to receive the electrical signals from the opto-electrical devices, the computer being caused by programming to process the electrical signals and thereby process optical information representing players' faces and optical information representing their wagered gaming chip(s).

The system may also include at least one indicator device associated with each playing position, each indicator device being coupled to the processor, and the processor being caused by programming to control each indicator device in response to the signal input to the processor of electrical signals associated with respective optical devices that provided light to which the respective electrical signals are related.

The system's processor may also be caused by programming to associate information carried by the electrical signals with respective optical devices that provided light to which the respective electrical signals are related. The information represented optically on the chips represents the denomination of the respective chip, and the processor is caused by programming to also associate the sum of all of the denominations of chips at a respective location with the respective optical device.

The invention further provides for a combination casino imaging system that identifies faces and wagered chips at a casino table game, the system having more than one imaging device and associated electronic apparatus including at least one computer and at least one frame grabber. The imaging devices may be positioned in one location of the gaming table, such as under the dealer's chip tray, and, preferably, are mounted on one imaging device assembly. The combination system may also benefit from casino personnel or security personnel confirming the identity of a person whose face has been identified. The system may also includes means to indicate during each casino game that one or more players have been identified, and means to also indicate that one or more wagered chips have been identified.

In one embodiment, the invention provides a system for associating information related to one or more gaming chips wagered at each of a plurality of playing positions on a gaming table and information related to a face of each of a plurality of players at a respective playing position. That system comprises at least one imaging device associated with each of the plurality of playing positions which receives light from the respective player's face and light from the respective playing position including light from any gaming chip or chips wagered thereat and provides information related to such received light, and at least one computer which receives information provided by the at least one imaging device. The at least one computer is programmed to process information provided by the at least one imaging device related to light from a respective player's face and light from a respective playing position and associate respective face and waging chip information. The at least one computer can be a computer at the particular computer, or a casino computer, or both.

In another embodiment, the invention provides a system for identifying players at a gaming table having a plurality of playing positions from face information and associating wagering information with an identity of an identified player. That system comprises at least one video camera that captures face information from each player at a playing position and wagering information from gaming chips wagered at each of the plurality of playing positions with which a player is associated, at least one frame grabber which provides face and chip information for processing on a frame-by-frame basis from information provided by the at least one video camera, and at least one computer which identifies the player from frames provided by the frame grabber and determines wagered sums from frames provided by the frame grabber, and associates the wagering information with the identity of the associated player.

The invention also provides a method for associating information related to one or more gaming chips wagered at each of a plurality of playing positions on a gaming table with an identity of each of a plurality of players at a respective playing position. The method comprises providing, in association with each of the plurality of playing positions, information related to a respective player's face using light from the respective player's face and information related to a respective playing position including any gaming chip or chips wagered thereat using light from a respective playing position, attempting to determine an identity of each player associated with a playing position based on the information related a respective player's face and stored data; and associating information related a respective player's face with information related to a respective playing position.

In the preferred embodiment, the identity of each player is attempted by comparing information related to a respective player's face and stored data. However, if that fails, the player is permitted to continue and his or her identity is attempted through inquiry or other means.

### BRIEF DESCRIPTION OF THE DRAWINGS

The FIGS. are not drawn to scale.

FIG. 1: A top planar view of a blackjack table 12 with two players 14 and showing imaging devices 16 (from FIG. 2A) in the area of the dealer's chip tray 18, and showing other blackjack table devices and paraphernalia including seven betting positions 20, one betting position specified for each player, (some casinos use only six betting positions at blackjack), a card shoe 22, a spent card holder 24, and money slot receptacle 26, and auxiliary data input device 28 that may or may not include a comp card holder (shown on the corner of the table, and overhanging the table, where the two players are located), a dealer's card sensor 30 (see applicant's pending application Ser. No. 09/335,100) that may be incorporated with an electronic or prism device to tell if a dealer's down card makes blackjack for the dealer, and a table support leg 34 with a table computer 36 mounted thereto under the table to which various table devices are connected to directly or through another table device. The table computer would contain one or more frame grabbers.

FIG. 2A: A top planar close up view of an imaging device assembly 17 that may be located under a dealer's chip tray 18. The assembly shows seven combination imaging devices 16, one to image each player's face as well as bets placed in that player's betting position.

FIG. 2B: A top planar close up view of an imaging device assembly 17a that may be located under a dealer's chip tray 18. The assembly shows seven square chip imaging devices 16a, one for each players' betting position, and showing three rectangular imaging devices 16b to capture facial images interspersed among the seven chip imaging devices.

FIG. 2C: A top planar close up view of an imaging device assembly 17b that may be located under a dealer's chip tray 18. The assembly shows seven square chip imaging devices 16a, one for each players' betting position, and showing one rectangular imaging device 16c to capture facial images near the middle of the seven chip imaging devices. The one facial imaging device 16c may capture all seven players' facial images collectively in one frame, or it may be adapted to rotate in order to capture the seven players' facial images individually, or to capture two or more faces at a time.

FIG. 3A: A side view of an imaging device 16 mounted to an imaging device assembly plate 40 located behind a transparent protective plate 42 and under a dealer's chip tray 18 so that the imaging device's lens 44 is aimed above the blackjack table playing surface 46 toward the players and their betting positions.

FIG. 3B: A side view of an imaging device 16 mounted to an imaging device assembly plate 40 located behind a transparent protective plate 42 and under a dealer's chip tray 18 so that the imaging device's lens 44 is aimed above the blackjack table playing surface 46 toward the players and their betting positions 20. The chip image data enters the imaging device 16 through a portion of the lens 44, while the facial image data reflects off mirrored lenses 45a into the another portion of the lens 44 of the imaging device providing a single frame with chip(s) image data and facial image combined.

FIG. 3C: A side view of an imaging device 16 mounted to an imaging device assembly plate 40 located behind a transparent protective plate 42 and under a dealer's chip tray 18 so that the imaging device's lens 44 is aimed above the blackjack table playing surface 46 toward the players 14 and their betting positions 20. By using multiple mirrored, transparent or opaque/reflective optics 45a, 45c in the optical path for the face or the optical path for the chip(s) 50, or both optical paths, both the chip image data and the facial image data enter substantially the same portion lens 44 of the imaging device 16 at different times. This embodiment provides different frames of data separately (alternate frames, or some other sequence of frames), i.e., frames with (only) a chip(s) image, and other frames with (only) a facial image.

FIG. 3D: A side view of an imaging device 16 mounted to an imaging device assembly plate 40 located behind a transparent protective plate 42 and under a dealer's chip tray 18 so that the imaging device's lens 44 is aimed above the blackjack table playing surface 46 toward the players 14 and their betting positions 20. By using a mirror 45a, a semi transparent reflector 45c, such as a half-silvered (one-way) mirror and two electronic shutters 47a, 47b in the two optical paths, both the chip image data and the facial image data enter substantially the same portion lens 44 of the imaging device 16 at different times. This embodiment also provides different frames of data separately (alternate frames, or some other sequence of frames), i.e., frames with (only) a chip(s) image, and other frames with (only) a facial image.

FIG. 4: A block diagram of a combination imaging assembly 60 that captures both facial images and images of wagered chips 50 at a blackjack casino table game. One of the two imaging devices 16b shown may be used for one player's face (or more than one players' faces as described, for example, in association with FIG. 2B) and the other 16a of the two imaging devices shown may be used for a player's wagered chips 50. The two imaging devices 16a, 16b are shown multiplexed (multiplexer 62) and may be connected to the imaging device assembly printed circuit board 64 (along with the other imaging devices to cover all players and their respective betting positions), which is connected to a multiplex assembly printed circuit board 68 (separate connectors from the imaging devices 16a, 16b to the multiplex assembly 68 may be used), which is connected to the table's computer 36, which is connected to a casino server 70 (along with other table computers not shown), which is connected to the casino computer and database 72. (In another embodiment, each imaging device used may be separately mounted to the gaming table and individually connected to the multiplex assembly.)

FIG. 5: A block diagram of a combination imaging assembly 60a that captures both facial images and images of wagered chips 50 at a blackjack casino table game. The imaging devices 16b, 16a(two are shown, one for face(s) and one for chips) are connected to the imaging device assembly printed circuit board 64 that incorporates a multiplex switching assembly. The combination imaging assembly 60a is connected to the table's computer 36, which is connected to a casino server 70 (along with other table computers not shown), which is connected to the casino computer and database 72.

FIG. 6: A block diagram of a combination imaging assembly 60b that captures both facial images and images of wagered chips at a blackjack casino table game. The imaging device 16 (only one, which may be used for one player's face and his wagered chips, for example, is shown in FIG. 6) is connected to the imaging device assembly printed circuit board (along with the other imaging devices that are used) that incorporates the required multiplex switching assembly. The combination imaging assembly is connected to the table's computer 36, which is connected to a casino server 70 (along with other table computers not shown), which is connected to the casino computer and database 72.

### DESCRIPTION

The term “imaging device” is used in a broad sense and encompasses optical and electronic gray-scale and color digital and analog devices such as video cameras, and includes any opto-electrical device such as CCD and CMOS devices with one or more associated optical devices coupled thereto such as a pinhole lens, lens, mirror, semi transparent reflector, single reflex lens, shutter, shutter/reflector or the like, which may be used for capturing frames of optical information electronically for subsequent real-time or delayed processing in a computer system operating under the control of programmed instructions. Imaging devices may be situated in one location and may be assembled into an imaging device assembly that may be mounted to or associated with a casino table game such as blackjack and baccarat. Captured image data may be provided to one or more frame grabber board(s).

Typically, table game players may be identified by their personal comp card, i.e., a player identification card that is issued by the casino to each player. Such cards store ID information in different ways including in a magnetic strip which may be read by swiping in a magnetic reading device when a player starts a playing session. Other types of customer ID cards may be used and read with appropriate reading devices, e.g., cards with punch holes may be used, or smart cards (with electronic memory, etc.) with conductive contacts may be used, or radio frequency cards with battery or passive r-f electronic apparatus (antennae, memory, etc.) may be used. (One example of a passive r-f card is offered by Cubic Incorporated in California; Cubic provides r-f cards for access to public transportation systems).

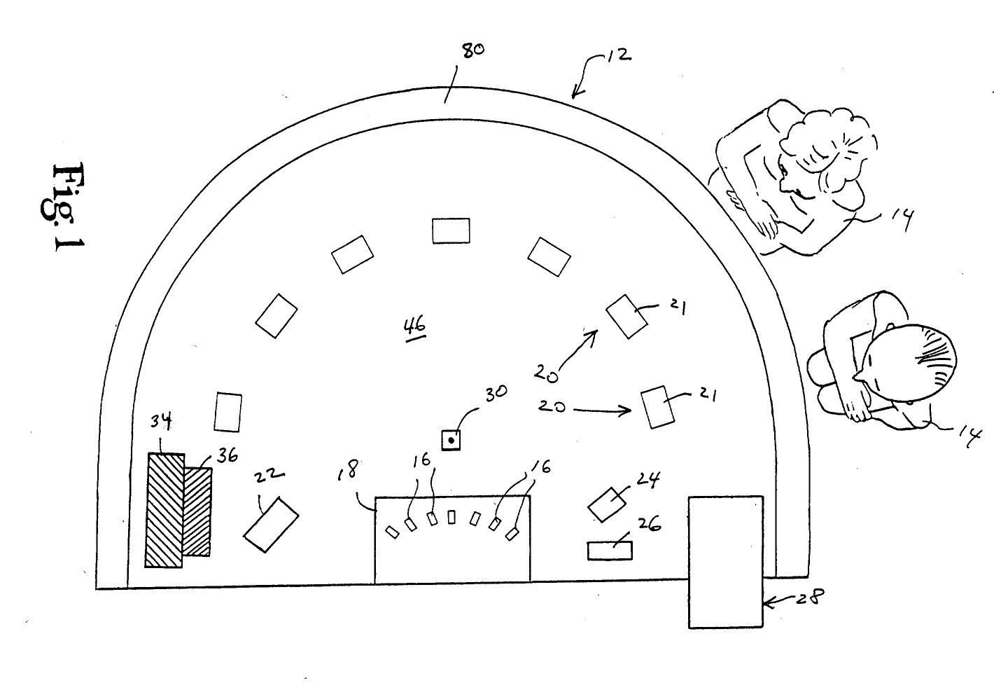

Referring to FIG. 1, a magnetic reading device 28 for comp cards (not shown) may be associated with an auxiliary data input device shown in FIG. 1, or a separate magnetic reading device may be provided for each player 14 in the elbow rail 80 or on the table surface 46. (Also see, for example, applicant's pending application Ser. No. 09/335,100.)

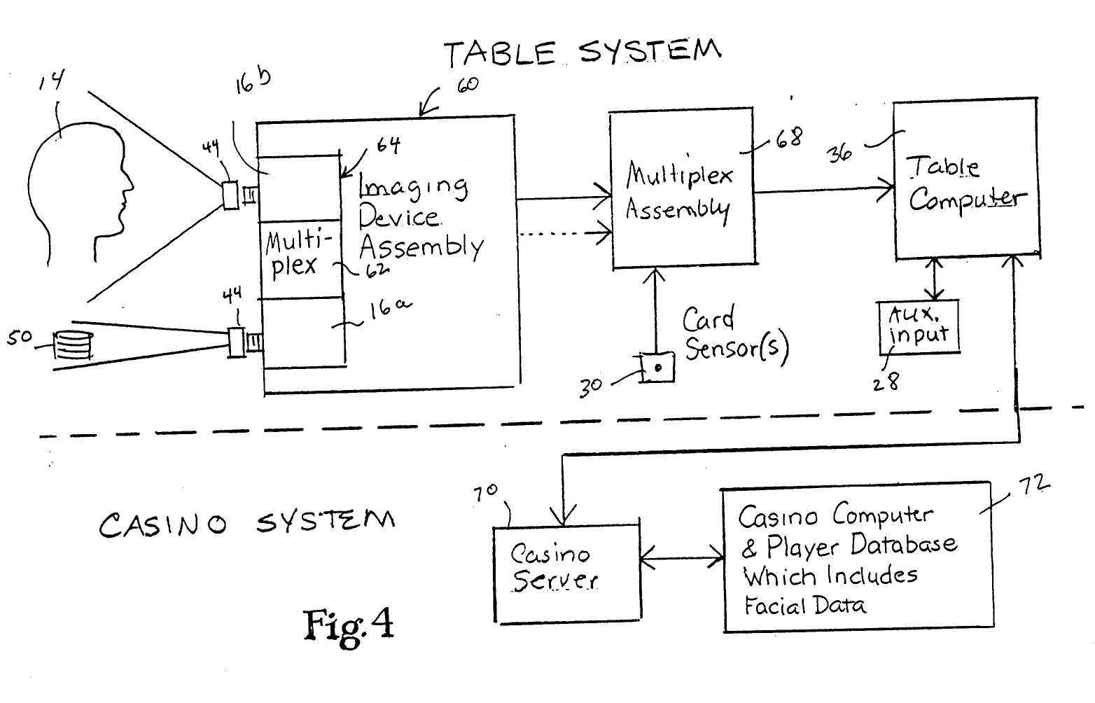

When such cards are issued to a player, or at other times, the casino's computer imaging system (not shown) may capture a facial image with an imaging device (not shown) and store data representing that player's face in a casino database (72 in FIG. 4) along with and/or associated with other identification information such as the player's account number, name, address, phone, birthday, occupation, interests, etc. Casinos already store this type of information for marketing, statistical and other purposes.

This would allow a casino to subsequently identify players automatically, using imaging devices, without the use of a comp card or in conjunction with a comp card. Facial image recognition may be augmented by one or more other biometrics recognition techniques, such as iris, fingerprint, voice, heart beat, electrical, magnetic, krillian, and the like, and suitable optical apparatus, or other specialized apparatus, may be employed as required.

For example, when a new player 14 sits down to play at a particular playing position 20 with a specified location 21 on the felt to place bets (as shown in FIG. 1) at a particular blackjack table 12, for example, the player's facial image may be captured by an imaging device 16 (FIG. 4) operating with a table computer 36.

Each blackjack table 12, for example, would have an associated table computer 36, such as a PC computer, to perform various functions at the table, such as processing optical data in one or more frame grabber board(s) (not shown but within block 36) from each table's various imaging devices, 2-way communication to the casino(s) server(s) and/or database(s), compile and process betting and other data from each hand played and from each player's play session from beginning to end, process data from the playing cards to determine the ranking or value of dealt cards, tally financial and other information from each dealer's dealing session from beginning to end. In various ways, using the auxiliary data input device 28 shown in FIG. 1, which could be operated by keypad, touch screen, etc., dealers could sign in at the start and out at the finish of their dealing session, etc. (also see, for example, applicant's pending application Ser. No. 09/335,100). A table PC computer 36 is depicted in FIG. 1 located under the playing surface 46 mounted to a leg 34 supporting the table as also shown in FIG. 1.

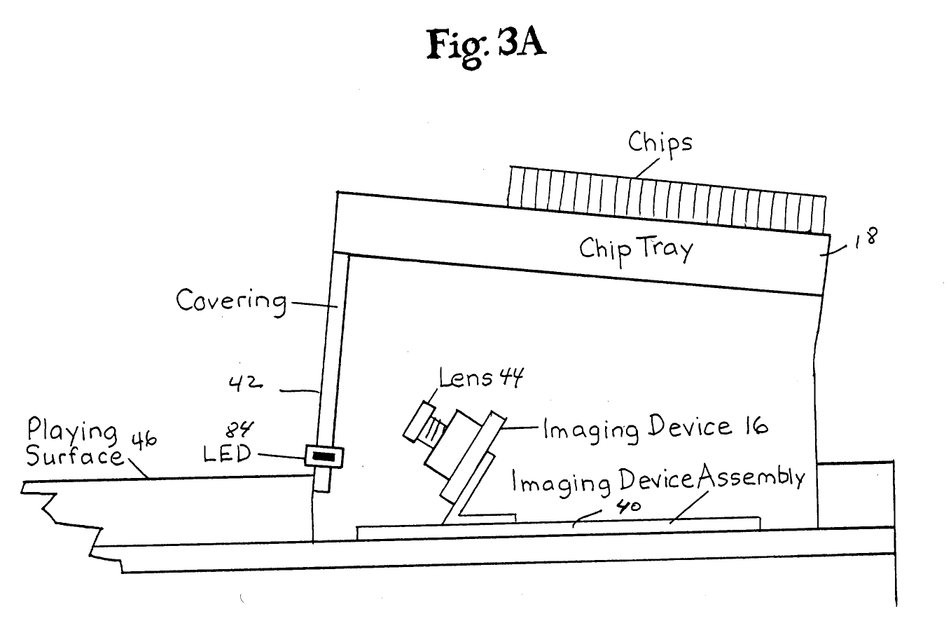

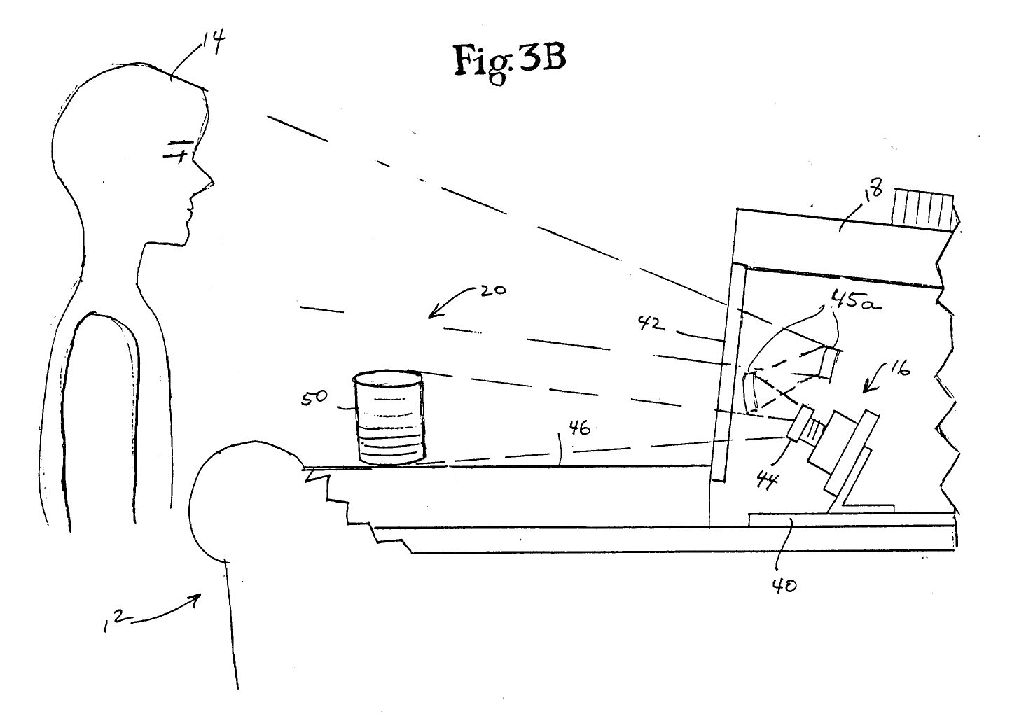

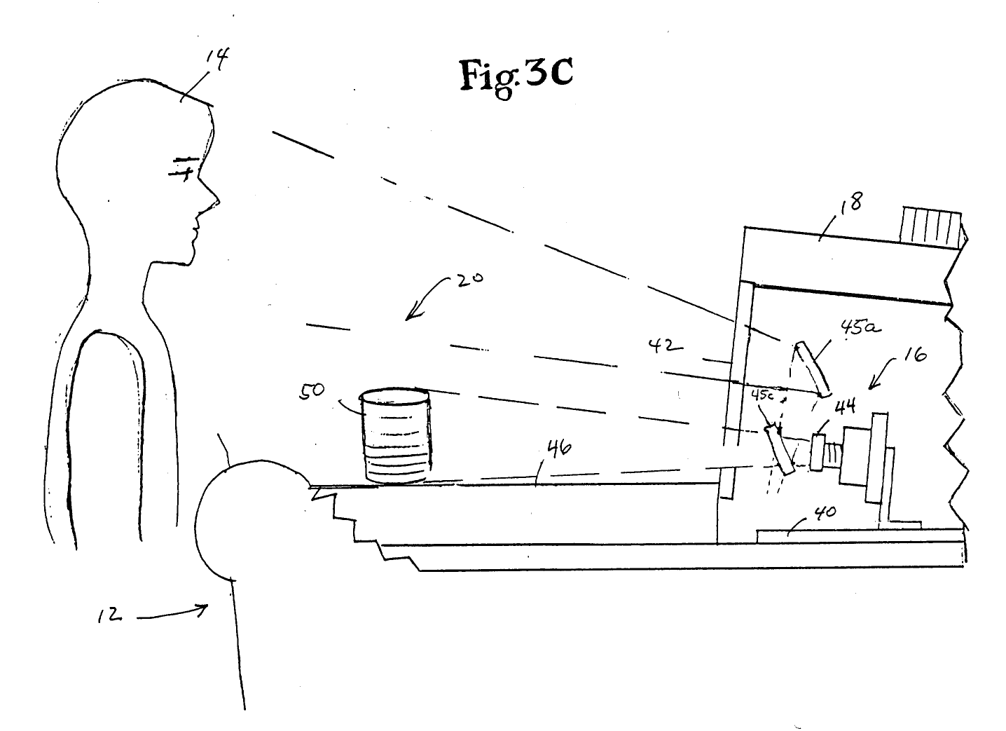

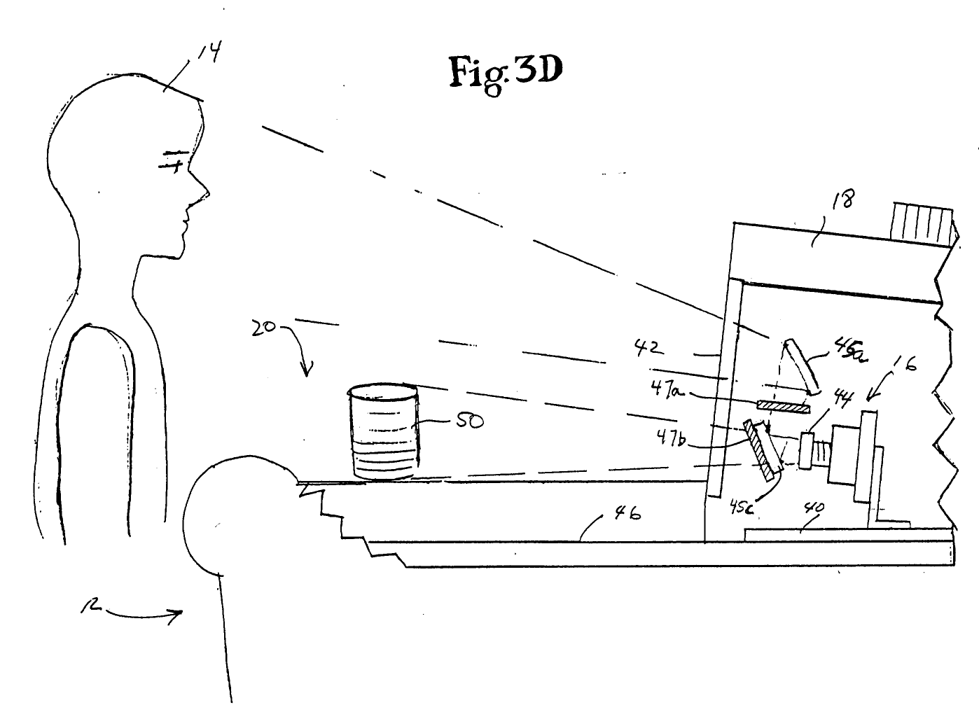

Devices that may be controlled in whole or in part by the table computer 36 include the imaging devices 16, LEDs 84(FIG. 3a) (Comp Lights, described below), the dealer's card sensor 30, an auxiliary data input device 28, comp card, playing card and/or currency reading devices, etc.

Facial data captured from a table's imaging devices 16 and processed in a table's computer 36 and uploaded so that it may be compared to data from stored data of players' faces from the casino database 72. This comparison operation may initially be performed in a computer storage device located elsewhere from the table computer 36 if the casino's stored facial images are not redundantly stored in individual tables' computers.

When a match is made at a blackjack table for example, the player's account number, name, etc. will thus become known to the casino system as well as just where that player has sat down to begin playing. Upon matching a new player's facial image with a known player's stored facial image from the casino database 72, a play session file for that player can be opened in a blackjack table's computer or elsewhere in the casino.

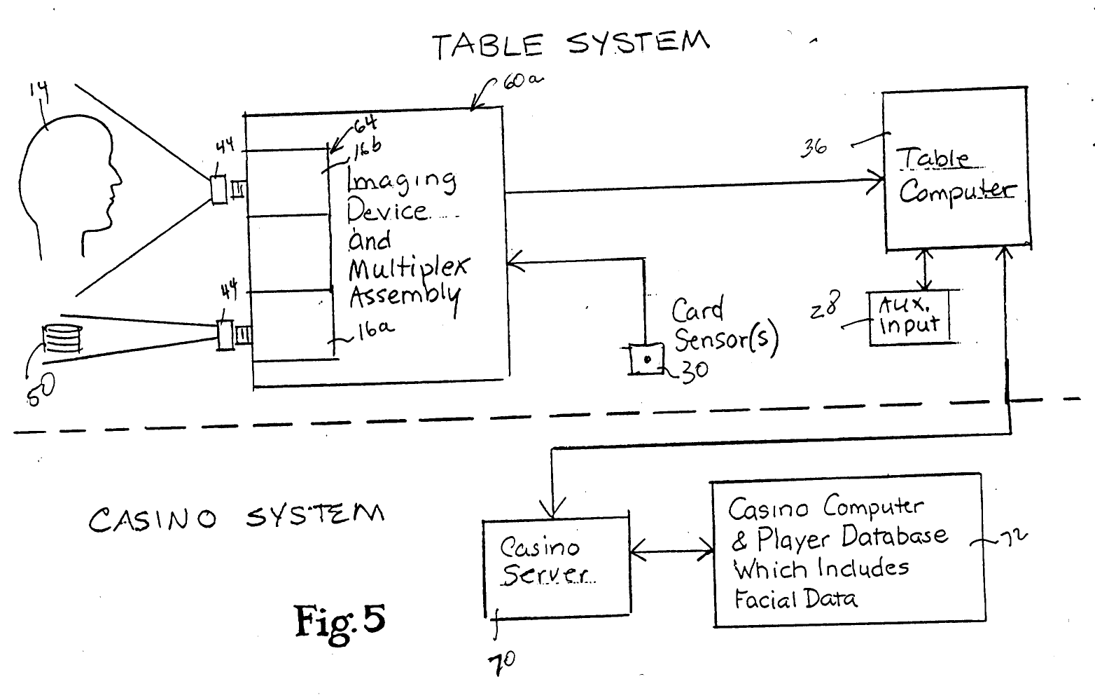

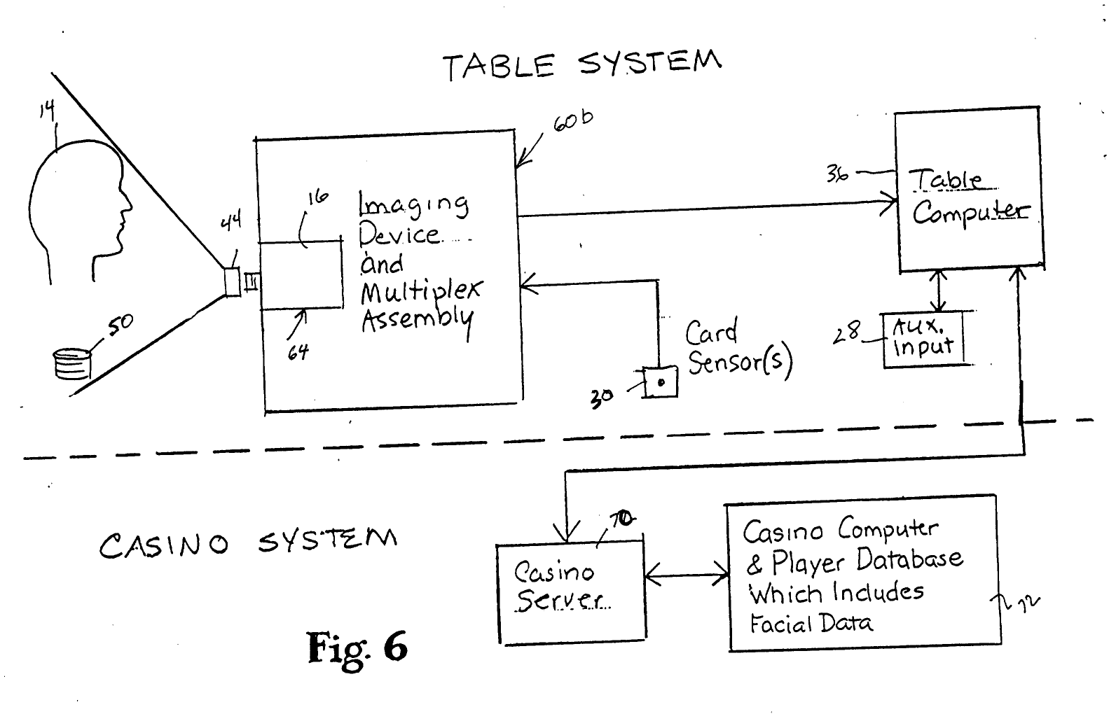

After a match to a known player is made, that facial data from the database 72 may be downloaded to the table computer 36 for storage (at least for temporary storage) so that facial images captured from the imaging devices 16 at the table and processed in the table's computer 16 may be continually compared to the downloaded image (please refer to FIGS. 4, 5 and 6). When a match may no longer be made from subsequent comparisons, it would indicate that the player has left and the table computer can then end that player's play session.

Ending a play session and other functions may be augmented by the dealer keying in or otherwise (such as a touch-screen device) entering information into an auxiliary input device 28 associated with each table as shown in FIG. 1.

Referring to FIG. 1, the system may also provide one or more sensors (such as sensor 30) in the table, card shoe or elsewhere which sense card movement or placement on the gambling table, and/or placement and/or movement of gaming chips 50 on the gambling table 12, so that the table computer 36 can automatically detect one or more points in the cycle of a card game such as, 1) hand active, and, 2) in-between hands. In this manner, the number of active hands a player plays can be counted, and the table computer can track each bet a player makes each hand, and calculate the total amounts a player bets each play session, the player's average bet per hand per play session, etc. for each player.

Devices could be employed to track the cards dealt to each player and the dealer. For example, cards could be scanned by OCR means as they are dealt out of the card shoe 22. Or cards could be bar-coded (or otherwise coded) and their bar-codes captured and decoded as they are dealt. Or cards can be read after shuffling and their order recorded in a list electronically prior to being dealt so that by counting the cards' position as they are dealt from the deck of cards the ranking or value of each card could be determined by referring to the list. By tracking the cards, a player's winning and losing hands can be automatically determined by the table's computer 36. When a player wins a hand, the table computer may also read the winning payment amount paid by the dealer using the table's imaging devices so that that amount could be compared to the amount the player wagered that hand. In this manner or otherwise the table computer can keep track of the accuracy of the dealer's payments of winning bets (also see, for example, applicant's pending application Ser. No. 09/335,100).

As mentioned above, when a player leaves a table 12, a match will no longer be made from subsequent attempted comparisons for that playing position 20. But if a different facial image is captured at that position 20, i.e., an image that no longer matches, it would indicate that another player has sat down to play, and the process may then start over for the new player to try to start a new play session if the new player's face is matched up with a face stored in the casino's database system.

If the new player is unknown to the casino's facial storage database system 72, a play session may be started none the less and the player comped appropriately and/or signed up as a known player for future purposes after the play session has been completed.

Some casinos have banned cheats and other undesirables from playing at their casino. If the casino also stored facial data representing these banned players in the same or associated databases, or databases serving the needs of more than one casino accessed by communication means including, for example, the Internet, they could be automatically identified and subsequently ejected from the casino by security personnel.

Some gambling operators operate many casinos located in one or more gaming jurisdiction (such as Harrah's and Park Place Entertainment). Such multi-property operators may exchange player and other data from their respective databases and/or maintain a shared database containing facial images accessible by some or all of their casino properties by communication means including, for example, the Internet. (Security would be a concern; a given casino operator may want to take adequate precautions to prevent competitors from being able to access their databases.)

Data representing the faces of known terrorists and other criminals at large could be received from the FBI, CIA, Interpol and other sources and also stored in the casino's database(s) 72, so that a wanted person could also be automatically identified and apprehended by security people, or local police or the FBI alerted per previous received instruction from police or the FBI so that the wanted person could be followed or apprehended. Casinos may also access enforcement authorities' databases to identify wanted persons remotely (without storing such data in their own casino databases) using communication means such as the Internet, wireless, etc.

### IMAGING DEVICES

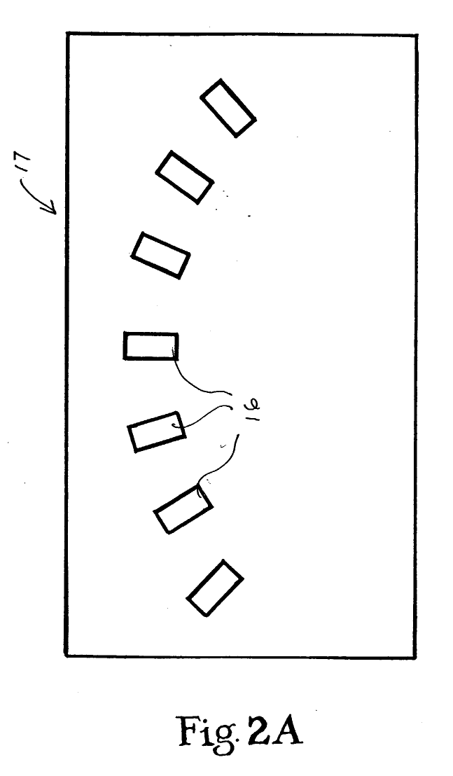

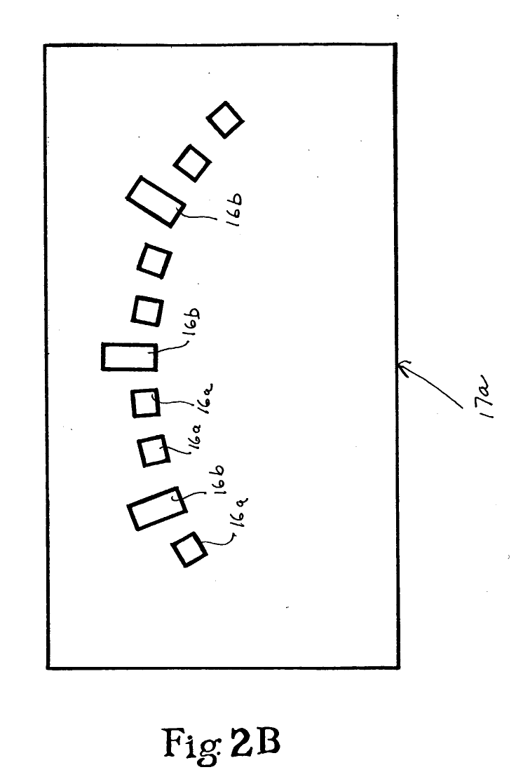

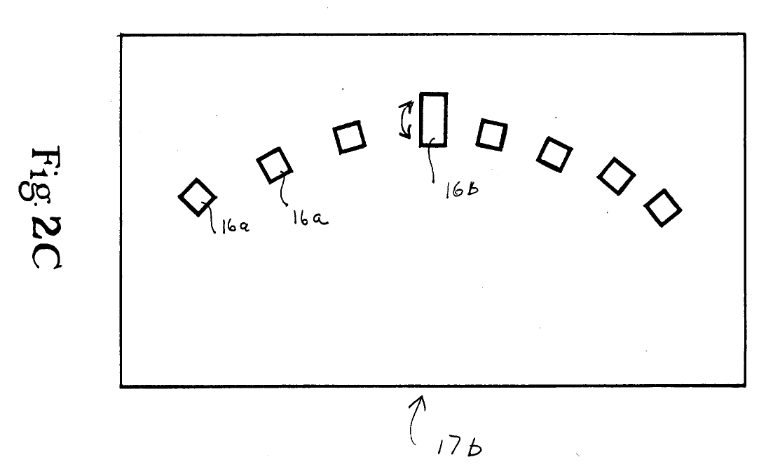

A dealer's chip tray area 18 is depicted in FIG. 1 (located in the central area along the edge of the straight side of the blackjack table). FIGS. 2A, 2B and 2C depict various imaging device assemblies 17, 17a, 17b described below. The same imaging device that captures facial images, or additional imaging devices, may be use to gather image data from individual players' wagered gaming chips, so that the casino can capture, process and store betting information for each player. This would allow the casino to issue comp credits proportional to or related to the level of play of each player it identifies by facial recognition, comp card or otherwise.

The two functions of capturing facial images and images of wagered chips may be combined into one imaging device. More than one imaging devices or types of imaging devices may be mounted in a common location, preferably on a common imaging device assembly.

The imaging device assembly 17, 17a, 17b (FIG. 2A, 2B or 2C) may be located under a blackjack dealer's chip tray as depicted in FIGS.1 and 3A, 3B, 3C and 3D so that the lens 44 of the imaging devices 16 are at or a little above the level of the blackjack playing surface.

A covering 42, i.e., a transparent or partially transparent material such as clear, coated or smoked glass or plastic or the like, may be located in front of or surrounding the common location of the imaging devices 16, or the imaging devices assembly 17, 17a, 17b (please see FIGS. 3A, 3B, 3C and 3D). Purposes of this covering 42 include the following: to protect the imaging devices from dust, dirt, spilled or splashed beverages, being touched, etc., and to obscure or partially obscure the imaging devices from view.

Either gray scale or color imaging devices may be suitable for facial recognition. A color imaging device may be preferable to a gray scale device to read chips with less sophisticated, old-fashioned color coded spot patterns which are repeated around the chips peripheries.

If gaming chips' peripheries were coded with more sophisticated repeated denomination patterns, patterns that may include error control features (please see applicant's pending application Ser. No. 09/335,100), gray scale imaging devices may be preferable to read the denomination values of the chips.

The imaging device assembly (e.g., 60 in FIG. 4) may incorporate a printed circuit board (e.g., 62 in FIG. 4) with video connections so that each imaging device used may be hard wired to the circuit board, or a wire cable and individual imaging device connectors may be used to connect each imaging device to the circuit board. The imaging devices 16 may be optically pre-aligned and focused and physically mounted to the circuit board in a precise manner to maintain alignment and focus, or the imaging devices may be optically aligned and focused after being mounted to the circuit board. The imaging device assembly's circuit board may also include multiplex circuitry as required by the combination imaging system.

Or the imaging devices on the imaging device assembly may be connected via cables and connectors to the circuit board of a multiplex assembly (e.g., 68 in FIG. 4) located separately from the imaging device assembly (e.g., 60). For example, the imaging device assembly (e.g., 60) may be connected to a multiplex assembly (e.g., 68) that may be located in convenient association (e.g., between) with the imaging device assembly and the table's computer.

The circuit board (e.g., 64) in the imaging device assembly (e.g., 60) or the circuit board in the multiplex assembly 68, may be connected to, and controlled by, the table's computer 36 that would contain one or more frame grabber boards to process image data.

The multiplex assembly circuit board 68 may contain switching circuitry and components that operate under the control of the table computer 36 so that, for example, input from the imaging devices 16 are sequenced and cycled in accord with software programs operating in the table computer.

In addition to, or instead of, operating under program control from the table computer 36, control programming for the imaging devices, LEDs (Comp Lights, described below), dealer's card sensor, auxiliary data input device, comp card, playing card and/or currency reading device, etc., may be contained in an appropriate memory chip, e.g., a programmable logic array, mounted on the imaging device assembly (e.g., 60), and/or on the multiplex assembly (e.g., 68) and/or otherwise.

Referring to FIG. 2A, seven imaging devices 16 located under the dealer's chip tray 18 are depicted, one for each player position as also depicted in FIG. 1. In this embodiment, each imaging device reads both the player's face and the player's bets. FIG. 3A shows one such imaging device 16 that may be used to read faces or chip(s). The facial data can be decoded from the upper portion of the frame of data, and the betting data can be decoded from the lower portion of the frame.

A bifocal lens 44 could also be used in this embodiment to improve the quality of the captured image data. An electronic shutter, electronic shuttered lens(es), split lens, a mirrored lens system, or a lens system with a mirror(s) or prism could also be used or used in combination.

It other embodiments it is possible to capture successive frames of image data and decode some frames for facial data for comparison purposes to identify players or undesirables, and decode other frames to determine for comping purposes how many chips of what denomination(s) a player has wagered.

Different frames of image data may be captured using a two-state or a variable lens device, or a compound lens device, in order to provide improved image data captured for faces and for bets. For example, as described below, the focus may be set differently when capturing a frame of data for gaming chips which are closer to the imaging device located under the dealer's chip tray, typically about 20 inches, then when capturing a frame of data for a player's face, which would typically be about 40 inches from the same imaging device.

Improved image quality might result from using auto-focus or two fixed focuses. For example, the imaging device 16 shown in FIG. 3A might incorporate a motor or solenoid to change focus from about 20 inches for a stack of chips, to about 40 inches for a player's face. Frames would be captured when focused at 20 inches for chips, and captured when focused at 40 inches for faces (possible sequencing for face and chip frame data capture is described below in association with FIGS. 3C and 3D).

It would also be possible to use a (semi) auto-focus device, for example, operated by sound or RF waves. If auto-focus were used, it may be helpful to signal the auto-focus circuitry to focus “far & up” for the capture of a facial image, or to focus “near & low” for chip(s).

A chip and facial combination imaging device is depicted in FIG. 3B which shows a side view of the imaging device 16 mounted to an imaging device assembly plate 40 located behind a transparent protective plate 42 and under a dealer's chip 18 tray so that the imaging device's lens 44 is aimed above the blackjack table playing surface 46 toward the players and their betting positions.

The chip image data enters the imaging device 16 through the lower half of the lens 44 and is received by half of the imaging device's pixel array, while the facial image data reflects off a first mirrored lens 45a onto a second mirrored lens 45b and is reflected from this second mirrored lens 45b into the top half of the lens of the imaging device and is received by the other half of the pixel array, thus providing a single frame with both chip(s) image data and facial image data.

Another embodiment is depicted in FIG. 3C which also shows a side view of one combination imaging device 16 mounted to an imaging device assembly plate 40 located behind a transparent protective plate 42 and under a dealer's chip 18 tray so that the imaging device's lens 44 is aimed above the blackjack table playing surface 46 toward the players and their betting positions.

In FIG. 3C, the facial image data reflects off a first mirrored lens 45a onto a second multifunction lens 45c which, while in a “first mirrored state” (described below), allows the facial image to be reflected from this second multifunction lens into the lens of the imaging device so that the facial image is received by substantially the full array of the imaging device's pixels which may be advantageous.

This second multifunctional lens 45c may be controlled by electronic signals and may be comprised of one or more optical elements which may change state (from one optical characteristic to one or more other optical characteristics) depending on the signal applied thereto via a conductor such as a wire or the like (not shown in FIG. 3C).

For example, while in its first electronically controlled state, this second multifunction lens 45c is set up and angled to be opaque and reflective—it reflects the facial image into the imaging device's lens as described above and at the same time it is opaque in the chip(s) optical path, i.e., it prevents the image of the chip(s) from reaching the imaging device's lens 44.

While in its second electronically controlled state, this second multifunction lens 45c becomes transparent and allows the facial image to pass right through it and thus not enter the imaging device's lens, and (having gone from opaque to transparent in this second state) it also allows the image of the chip(s) to pass through it and enter the imaging device's lens 44 so that the chip(s) image is received by substantially the full array of the imaging device's pixels.

The two states of the second multifunctional lens 45c would be under the control of programming resident in the table computer 36, multiplex assembly 68 or an imaging device assembly 60, 60a, 60b (FIGS. 4-6) or a combination thereof. Frames of facial image data and chip(s) image data need not alternate one after the other, i.e., face, chips, face, chips, face. . . . For example, during the “hand active” part of the play cycle, most or all of the frames of captured data may be of the chips (such “weighting” is also described below with an example); this would make it easier for the system to detect a cheater pinching or pressing (removing or adding chips to) a bet after cards have been dealt, for example. During the “in-between hands” period of the play cycle, all, most or many of the captured frames may be of the players' faces to determine, for example, if a player has left the game and a new player has sat down to play. During the in-between period, it may be helpful to capture some images of the chips, for example, to accurately operate the LEDs 84 (Comp Lights, described below) to indicate whether a bet has been placed or not, or to determine the amount bet immediately prior to the hand becoming active (please see, for example, applicant's pending application Ser. No. 09/335,100).

FIG. 3D is similar to FIG. 3C but FIG. 3D includes two electronic shutters 47a, b that are shown “hatched.” A first shutter 47a is shown generally horizontal between the two mirrors. A second shutter 47b is shown on the surface of the second (lower) mirror and facing the stack of chips. (The shutters may be incorporated with the mirrors, or could be mounted in different ways, on the mirror surfaces or separated therefrom.)

The second (lower) mirror 45c in FIG. 3D may be a semi-transparent reflector. A so-called one-way mirror, which may also be referred to as a half-silvered mirror, may be used. A one-way mirror has a reflective coating applied in a very thin, sparse layer which is so thin that it's called a half-silvered surface. It is referred to as half-silvered because the reflective molecules that coat the glass are so sparse that only about half the molecules needed to make the glass a full opaque mirror are applied. That is, at the molecular level, there are reflective molecules speckled all over the entire glass surface in an even film, but only half of the glass is actually covered, so that the half-silvered surface will reflect about half the light that strikes its surface, while letting the other half go straight through. (The secret to using a one-way mirror for a police station line-up, for example, is in the lighting—bright lights are used to light the suspects in the line-up room while dim lights only are used in the witness room.)

If no shutters were used in FIG. 3D, the imaging device's pixel array would receive through the imaging device's lens of the two images simultaneously, i.e., the images of the face and the chip(s) would be superimposed on each other on the pixel array. This superimposition is avoided by using the two shutters 47a, b (shown hatched), one shutter opaque and the other shutter transparent when capturing a facial image, and vice versa when capturing an image of a chip(s).

The two electronic shutters 47a, b are under the control of programming resident in the table computer, multiplex assembly or the imaging device assembly or a combination thereof. When a signal to one shutter is applied to cause it to be opaque, the opposite is true of the other shutter—a signal is applied to (or removed from) said other shutter to make it transparent (clear). In this manner, the combination imaging system is set up to capture either a facial image or the image of a (stack of) chip(s) as described below.

In FIG. 3D, when the upper shutter 47a (shown horizontally) is signaled to be transparent, and the other (lower) shutter 47b is signaled to be opaque, the facial image data reflects off the first (upper) mirrored lens 45a through the clear horizontal shutter 47a onto the'second half-silvered mirror 45c which allows the facial image to be reflected into the lens 44 of the imaging device 16 so that the facial image (only) is received by substantially the full array of the imaging device's pixels.

In FIG. 3D, when the shutter 47a (shown horizontally) is signaled to be opaque, and the other shutter 47b is signaled to be transparent, the facial image data reflects off the first (upper) mirrored lens 45a and is blocked by the opaque horizontal shutter 47a, while the image of the stack of chip(s) 50 travels through the transparent lower shutter 47b into the lens 44 of the imaging device so that the chip(s) image (only) is received by substantially the full array of the imaging device's pixels.

The use of the half-silvered mirror 45c in FIG. 3D reduces by about half the amount of light that the imaging device's pixel array receives from the image of the face and the image of the chip(s).

The sequence of capturing facial images and chip(s) images in FIG. 3D may be similar to that described for FIG. 3C. For example, during the “hand active” part of the play cycle, most or all of the frames of captured data may be of the chips, and during the “in-between hands” period of the play cycle, all, most or many of the captured frames may be of the players' faces.

In FIG. 2B, seven chip imaging devices 16a are depicted, one for each player's betting position, and a total of three separate facial imaging devices 16b are used to capture facial images (up to two to three faces per frame per facial imaging device), making a total of ten imaging devices.

The image capturing procedure used for FIG. 2B may be to capture and process (single) images from one or more chips piled-up in one or more stacks from each position in turn (i.e., from positions 1, 2, 3, 4, 5, 6 and 7 in sequence), and then to capture and process data from frames of facial image data from the three facial imaging devices for comparisons etc. of facial images from facial camera one (to identify players 1 and 2 at one end of the table), facial camera two (to identify the players 3, 4 and 5 in the middle positions), and facial camera three (to identify players 6 and 7 at the other end of the table) in a ten-step sequence (7 chip data images plus 3 facial data images).

And this ten-step sequence would be repeated continuously as long as the table game is open for business and being operated. This sequence may be “weighted” differently in the hand active part of the game cycle than in the in-between part of the game cycle. For example, the chip images from the seven chip positions may be captured, say, three times in immediate succession (thus, the number of chip images captured are “weighted”) before the facial images are captured once each during the hand active part of the cycle. During the in-between part of the game cycle, the facial images may be weighted.

Whatever imaging sequence is used may be interrupted temporarily for various purposes, such as security purposes (e.g., to only capture images of one particular suspect person), signing in another dealer, ordering chips to replenish the dealer's tray chip inventory, enter data about a particular player playing more than one positions, replacing a failing or failed component, etc.

Referring still to FIG. 2B, facial camera 16b one may be used to identify players sitting in positions 1 and 2 as follows: A facial image detected (from capturing and processing a frame's image data) on the left half of a frame would be known to be the image of player 1, and the facial image from the right half would be the image of player 2. The frame from the facial camera used to identify players 3, 4 and 5 in the middle, for example, would have a left, center and right section of the frame corresponding to players 3, 4 and 5 respectively.

In another embodiment, seven chip 16a and seven facial imaging 16b devices (14 devices) may be used with a fourteen-step sequence. For example, each of the seven rectangles depicted in FIG. 2A could represent two (different) imaging devices (making a total of 14 imaging devices), one of the two being used to capture the face image and the other used to capture the image of the player's wagered stack of chips. (Each of the seven rectangles in FIG. 2A was first described above as representing one imaging device.)

These two-imaging-devices-per-rectangle 16 (as a second possible depiction shown in FIG. 2A) may be mounted one atop the other (e.g., piggyback), or side by side; both could be mounted to the same printed circuit board, etc. Both imaging devices could be gray-scale, or both color, or one of each. Two or more frame grabbers may be employed to readily accommodate the use of two (different) imaging devices, afford faster throughput, simultaneous processing of a plurality of images, allow rapid processing of chip and facial images, reduce the delay sometimes associated with frame synchronization, etc. Two or more table computers for each table may also be used to an advantage. Each may contain one or more frame grabbers.

In FIG. 2C, seven chip imaging devices 16a are depicted, one for each player's betting position, and one additional facial imaging device 16b is used to capture facial images from all seven playing position. The one facial imaging device may capture all seven players' facial images collectively in one frame using an appropriate wide-angle lens, or it may be adapted to rotate in order to capture the seven players' facial images individually, one face per image frame, or to capture more than one face at a time. This may be accomplished by using a mechanical device, such as a stepping motor or solenoid, to rotate the facial imaging device to capture each player's facial image in turn.

The procedure used for FIG. 2C would involve at least an eight-step sequence similar to that described for FIG. 2B above. One of the eight steps, or more than eight steps, may involve capturing more than one image (for example, if one facial image for each playing position were captured, 14 steps may be used).

Dealers and other casino employees could also be identified automatically using facial recognition or other bio-recognition techniques. For example, the eye-in-the-sky may be used to recognize dealers, another imaging device could be mounted off the table or on the table, such as near the auxiliary input device, one of the imaging devices for players could be used, for example, when starting a dealing session, the dealer could place a device with a mirror in front on one of the player's face's imaging device to capture his own facial image, etc.

It may be useful to integrate imaging devices in other areas of the casino property and businesses operated by the casino. For example, it might be helpful for marketing, management and other purposes to recognize patrons (as well as cheats, criminals, terrorists, etc.) in the reception area of restaurants, hotel registration desks, gift shops, theaters, auditoriums, arenas, spas, gas stations, travel agencies, car and truck rental locations, ATMs, phone booths, etc.

### Interactive Combination Casino Table Game Imaging System to Confirm Face and Chip Recognition

On Nov. 1, 2001, reporter Leslie Gevirtz reported for Reuters that the American Civil Liberties Union and an independent security analyst voiced concerns about facial recognition. For example, that such facial technology was prone to making false matches and that wearing a pair of glasses could fool a facial recognition system.

Some of these concerns may be addressed. For example, casino employees, such as floor persons or pit bosses, associated with one or more table games could confirm that the identity of players recognized by the casino's facial recognition system is accurate and that a correct facial match has been made.

This could be accomplished by recording a physical description and/or a (regular) digitized picture of a player's face when a player signs up for a comp card or a comp account, or at other times. Then, after the casino system recognizes a player by facial recognition at a table game, this physical description or picture could be displayed on a monitor in the pit area for a casino employee (e.g., a pit boss or floor person) to review and confirm that a correct identification has been made (along with the player's personal preferences such as his favorite drink, restaurant, etc.).

The casino facial recognition system may also incorporate a “confidence level” rating associated with each match and display the confidence level on the pit monitor to assist the employee in confirming the match. If eyeglasses were a problem, the employee might suggest the player remove them to assure that he gets his full comp credit entitlement.

Depending on the confidence level or otherwise, it may be desirable, or perhaps it may be desirable in all cases, for the employee to then greet the player to build rapport and establish “brand loyalty” with the casino. For example, the employee might say: Hello Mr. Jones; can I order your favorite drink?, or make you a reservation for dinner?, etc. If he were a player other than Mr. Jones, the player would probably bring this to the employee's attention so that he gets the right drink and no hassles when he goes for dinner.

A casino employee located away from the table area may also confirm a player's identity. For example, a security person monitoring the eyes-in-the-sky surveillance cameras could be alerted when the computer imaging system at a table game initially identifies a player. The security person could then visually compare the system's stored image or picture, or the description of the player, to a fresh image taken with a security camera at a different angle.

Facial recognition accuracy could be enhanced if the casino's facial database were updated regularly. For example, when the player is recognized for a play session, possible changes due to aging, illness, sun, hair style etc. could be made to the data stored in the casino database by way of updating and maintaining more current data so that subsequent matches would have a higher confidence level.

Applicant's pending application Ser. No. 09/335,100 describes the use of a two color LED, called a Comp Light. Such uses include, letting the player see that his bet gets credited for comping purposes at the beginning of each hand, and to indicate if there is a problem reading chips that have been wagered, i.e., that the chip(s) correct value(s) have been identified. As also described, the colors and/or combination of colors and/or blinking from the two color LEDs may be used to interact with and keep each player individually informed if there is a problem reading a given bet, or (in the present application) recognizing a player's face, indicating whether the player is in fact signed in for comp credits for that play session, etc. A specific LED signal (color-wise, and/or blinking-wise, etc.) could be used to signal to the player that his face has not (yet) been recognized to start a play session so that he can adjust his pose, push his hair back, etc., and another signal may be used to signal that eyeglasses being worn should be removed for a (more) positive identification, or a combination of the above, etc.

Comp lights (e.g., 84) for the embodiments described herein may be mounted in the covering as shown in FIG. 3A, or the comp lights may be located higher up in the covering, i.e., closer to the bottom of the chip tray shown. FIG. 3A shows only one comp light 84 but in practice there may be one or more comp light for each player of the game. Each comp light may have an associated indicator to indicate the playing position that the comp light belongs to. For example, the indicators may be position number signs mounted near the comp light for respective positions. Or the position numbers may be fitted over the comp light so as to be illuminated by the colored lights of the comp light, or a small alpha and/or numeric display could be mounted instead of the LEDs and be used to display a greater variety of information to the players, and could even be used to promote additional patronage (such as gaming tournaments, performance events, special product sales or restaurant menus, etc.), display information about jackpots and progressive prizes, etc.

Alternatively, comp lights or other displays may be mounted into the table playing surface, in front of or behind the betting position for example, and wired below the playing surface to the table system. Instead of LEDs or small displays, other devices may be used. For example, a monitor, such as a CRT or flat screen device, may be associated with each gaming table so that all players can view it. A table monitor could be used to keep each player individually informed and/or all players at a table collectively informed. Marketing information could be offered to individual players or to more than one players, jackpots, progressive jackpots and other participation rewards could be promoted, etc.

1. A system for associating information related to one or more gaming chips wagered at each of a plurality of playing positions on a gaming table and information related to a face of each of a plurality of players at a respective playing position, comprising:
at least one imaging device associated with each of the plurality of playing positions which receives light from the respective player's face and light from the respective playing position including light from any gaming chip or chips wagered thereat and provides information related to such received light; and
at least one computer which receives information provided by the at least one imaging device;
the at least one computer being programmed to process information provided by the at least one imaging device related to light from a respective player's face and light from a respective playing position and associate respective face and waging chip information.

2. The system of claim 1 wherein each at least one imaging device comprises at least one video camera.

3. The system of claim 1 wherein each at least one imaging device is positioned at one general location on the gaming table.

4. The system of claim 3 wherein each at least one imaging device is positioned in the vicinity of a dealer's chip tray on the gaming table.

5. The system of claim 1 comprising at least one indicator device associated with each playing position, each indicator device being controlled by the at least one computer at least partially dependent upon the information provided by each respective at least one imaging device.

6. The system of claim 1 wherein a denomination of the chips is represented optically on the chips, and wherein the at least one computer is programmed to determine from information provided by a respective at least one imaging device a sum of the denominations of chips at a respective playing position and associate the sum with the respective playing position.

7. The system of claim 5 wherein the at least one computer is programmed to control respective at least one indicator devices to indicate whether a player associated with a respective playing position has been identified using information provided by the respective at least one imaging device.

8. The system of claim 5 wherein the at least one computer is programmed to control respective at least one indicator devices to indicate whether the denomination of at least one chip wagered at respective playing position has been identified using information provided by the respective at least one imaging device.

9. The system of claim 1 wherein the at least one computer is programmed to identify a player from information related to that player's face and stored data accessible by the at least one computer.

10. The system of claim 9 wherein a denomination of the chips is represented optically on the chips, and wherein the at least one computer is programmed to determine from information provided by a respective at least one imaging device a sum of the denominations of chips at a respective playing position and associate the sum with the respective playing position, the system comprising a database accessible by the at least one computer in which the sum information is stored in association with the identity of the player associated with the respective playing position.

11. The system of claim 1 wherein the at least one imaging device comprises an imaging device associated with each playing position to receive light respectively therefrom, and at least one imaging device that receives light from the face of each player at a playing position on the table.

12. The system of claim 1 wherein the at least one imaging device comprises an imaging device associated with each playing position to receive light respectively therefrom, and another imaging device associated with each playing position that receives light from the face of each player at the respective playing position on the table.

13. The system of claim 1 wherein the at least one imaging device comprises an imaging device associated with each playing position to receive light respectively therefrom and from the face of each player at the respective playing position on the table.

14. A system for associating information related to one or more gaming chips wagered at each of a plurality of playing positions on a gaming table and information related to a face of each of a plurality of players at a respective playing position, comprising:
means, associated with each of the plurality of playing positions, for receiving light from the respective player's face and light from the respective playing position including light from any gaming chip or chips wagered thereat and providing information related to such received light; and
means coupled to the means associated with each of the playing positions which receives information provided thereby for processing information related to a respective player's face and information related to a respective playing position and for associating respective face and waging chip information.

15. A method for associating information related to one or more gaming chips wagered at each of a plurality of playing positions on a gaming table with an identity of each of a plurality of players at a respective playing position, comprising:
providing, in association with each of the plurality of playing positions, information related to a respective player's face using light from the respective player's face and information related to a respective playing position including any gaming chip or chips wagered thereat using light from a respective playing position;
attempting to determine an identity of each player associated with a playing position based on the information related a respective player's face and stored data;
associating information related a respective player's face with information related to a respective playing position.

16. The method of claim 15 wherein attempting to determine the identity of each player comprises comparing information related to a respective player's face and stored data.

17. The method of claim 15 wherein attempting to determine the identity of a player if that player's identity was not determined using information related to that player's face and stored information comprises requesting identity information from that player.

18. The method of claim 15 comprising casino personnel visually checking the actual identity of an identified player using an image of that player.

19. A system for identifying players at a gaming table having a plurality of playing positions from face information and associating wagering information with an identity of an identified player, comprising:
at least one video camera that captures face information from each player at a playing position and wagering information from gaming chips wagered at each of the plurality of playing positions with which a player is associated;
at least one frame grabber which provides face and chip information for processing on a frame-by-frame basis from information provided by the at least one video camera; and
at least one computer which identifies the player from frames provided by the frame grabber and determines wagered sums from frames provided by the frame grabber, and associates the wagering information with the identity of the associated player.

20. The system of claim 19 wherein each at least one video camera comprises at least one video camera for each playing position.

21. The system of claim 19 wherein each at least one video camera is positioned at one general location on the gaming table.

22. The system of claim 21 wherein each at least one video camera is positioned in the vicinity of a dealer's chip tray on the gaming table.

23. The system of claim 19 comprising at least one indicator device associated with each playing position, each indicator device being controlled by the at least one computer at least partially dependent upon the information provided by each respective at least one video camera.

24. The system of claim 19 wherein a denomination of the chips is represented optically on the chips, and wherein the at least one computer is programmed to determine from information provided by the at least one frame grabber a sum of the denominations of chips at a respective playing position and associate the sum with the respective playing position.

25. The system of claim 23 wherein the at least one computer is programmed to control respective at least one indicator devices to indicate whether a player associated with a respective playing position has been identified using information provided by the at least one frame grabber.

26. The system of claim 23 wherein the at least one computer is programmed to control respective at least one indicator devices to indicate whether the denomination of at least one chip wagered at respective playing position has been identified using information provided by the at least one frame grabber.

27. The system of claim 19 wherein the at least one computer is programmed to identify a player from information related to that player's face and stored data accessible by the at least one computer.

28. The system of claim 26 wherein a denomination of the chips is represented optically on the chips, and wherein the at least one computer is programmed to determine from information provided by the at least one frame grabber a sum of the denominations of chips at a respective playing position and associate the sum with the respective playing position, the comprising a database accessible by the at least one computer in which the sum information is stored in association with the identity of the player associated with the respective playing position.

29. The system of claim 19 wherein the at least one video camera comprises a video camera associated with each playing position to receive light respectively therefrom, and at least one video camera that receives light from the face of each player at a playing position on the table.

30. The system of claim 19 wherein the at least one computer comprises a PC and the at least one frame grabber comprises a frame grabber PC card coupled to the PC.

31. The system of claim 19 wherein the at least one video camera comprises a video camera associated with each playing position to receive light respectively therefrom, and at least one video camera that receives light from the face of each player at a playing position on the table, the at least one frame grabber comprising a single frame grabber and the system comprising a multiplexer coupled to the cameras and the at least one computer.
